(19) United States
(12) Patent Application Publication
(10) Pub. No.: US 2015/0244464 A1
(43) Pub. Date: Aug. 27, 2015

(54) Operating a Node in an Optical Transport Network

(71) Applicants: Massimiliano Maggiari, Genova (IT); Michela Bevilacqua, Genova (IT); Carla Marcenaro, Genova (IT)

(72) Inventors: Massimiliano Maggiari, Genova (IT); Michela Bevilacqua, Genova (IT); Carla Marcenaro, Genova (IT)

(73) Assignee: Telefonaktiebolaget L M Ericsson (publ), Stockholm (SE)

(21) Appl. No.: 14/425,402

(22) PCT Filed: Sep. 6, 2012
(86) PCT No.: PCT/EP2012/067427

§ 371 Date: Mar. 3, 2015

(51) Int. Cl. H04B 10/27; H04J 14/02

(52) U.S. Cl. CPC H04B 10/27; H04J 14/02

(57) ABSTRACT

An optical transport network (4) comprises a first node (10) connected to a second node (11) by a link (21). The second node (11) is capable of operating at a first value of tributary slot granularity and a second value of tributary slot granularity. The second node (11) receives (103) a first signalling message (102) from the first node (10). The second node (11) determines (106) if the same value of tributary slot granularity is configured at the second node (11) and the first node (10). If it is determined that the same value of tributary slot granularity is not configured at the second node and the first node, the second node (11) determines if it should force a setting of the tributary slot granularity. If it is determined that the second node should force a setting of the tributary slot granularity, the second node forces (114) a setting of the tributary slot granularity to a same value as configured at the first node.

### TECHNICAL FIELD

This invention relates to optical transport networks and to a method of operating a node in an optical transport network.

### BACKGROUND

An optical transport network (OTN) comprises a large number of components, such as routers, cross-connects, add-drop multiplexers. A pair of nodes in an optical transport network may support a large number of connections, where each connection can comprise multiple data links when multiplexing techniques such as Time Division Multiplexing (TDM) and Wavelength Division Multiplexing (WDM) are used. For scalability reasons, multiple data links can be combined into a single Traffic Engineering Link (TE Link). The purpose of forming a TE link is to group/map the information about certain physical resources (and their properties) into the information that is used by routing protocols such as Constrained Shortest Path First (SPF) for the purpose of path computation, and by Generalised MultiProtocol Label Switched (GMPLS) control plane signalling.

One of the GMPLS protocols is the Link Management Protocol (LMP), defined in RFC4204. LMP is a standard stack protocol that runs between a pair of nodes and it is used to manage the network connectivity in terms of TE Links. LMP comprises two procedures. Firstly, it verifies the reachability of the control channel interfaces that are used to carry control plane signalling between nodes. Secondly, it performs link property correlation, which ensures the properties of the group of data links forming a TE Link are the same at both end points of the links.

The main OTN standard is ITU-T G.709 “Interfaces for the Optical Transport Network (OTN)”. ITU-T G.709 has been revised a number of times to add new features. To enhance OTN flexibility, the latest revision of G.709, known as G.709-V3 introduces new ODU containers (ODU0, ODU4, ODUFlex) and a new Tributary Slot (TS) granularity of 1.25 Gbps. Some extensions have been made to the LMP for

G.709-V3.

The introduction of the new Tributary Slot granularity, 1.25 Gbps, causes some compatibility issues with legacy network equipment which has already been deployed before the introduction of ITU-T G.709-V3.

From a control plane perspective, it is necessary to discover which type of TS is supported at each end of a link, so that a node can choose and reserve the TS resources correctly in this link for the connection. An Internet Engineering Task Force (IETF) Internet draft “Link Management Protocol (LMP) extensions for G.709 Optical Transport Networks”, draft-zhang-ccamp-gmpls-G.709-lmp-discovery-05.txt proposes a LMP extension to discover the capability of a Higher Order Optical Data Unit (HO ODU) link, including the granularity of Tributary Slot to be used and the Lower Order Optical Data Unit (LO ODU) signal types that the link can support.

There are still some issues with operating an OTN in which at least some of the nodes have a capability of operating at 1.25 Gbps and 2.5 Gbps. One issue concerns equipment which lacks backwards compatibility at the data plane level. Some network equipment can support Tributary Slot granularities of 1.25 Gbps and 2.5 Gbps but cannot automatically revert to the 2.5 Gbps granularity at the data plane level.

### SUMMARY

An aspect of the invention provides a method of operating a second node in an optical transport network. The second node is connected to a first node by a link. The second node is capable of operating at a first value of tributary slot granularity and a second value of tributary slot granularity. The method comprises, at the second node, receiving a first signalling message from the first node. The method further comprises, at the second node, determining if the same value of tributary slot granularity is configured at the second node and the first node. If it is determined that the same value of tributary slot granularity is not configured at the second node and the first node, the method further comprises, at the second node, determining if the second node should force a setting of the tributary slot granularity. If it is determined that the second node should force a setting of the tributary slot granularity, the method forces a setting of the tributary slot granularity to a same value as configured at the first node.

An embodiment of the invention can have an advantage of allowing a node to be configured to operate at a particular value of tributary slot granularity via control plane signalling. This can allow a traffic path to be established in situations where it may not otherwise be possible to establish the traffic path. An embodiment of the invention can be used in a situation where the second node lacks backwards compatibility at the data plane level.

Advantageously, the first signalling message specifies the value of tributary slot granularity configured at the first node. The value of tributary slot granularity configured at the first node can be the same as a value of tributary slot granularity requested of the second node.

Advantageously, the first signalling message can comprise an information element which indicates whether the second node should force a setting of the tributary slot granularity. The step of determining if the second node should force a setting of the tributary slot granularity comprises checking a value of the information element in the first signalling message.

Alternatively, the method can further comprise sending a signalling message to the first node indicating that the second node supports a forced setting of the tributary slot granularity. The step of determining if the second node should force a setting of the tributary slot granularity comprises determining if a further signalling message is received from the first node indicating that the second node should force a setting of the tributary slot granularity.

Advantageously, the method further comprises determining Lower Order Optical Data Unit, LO ODU, types supported at the first node and the second node.

Advantageously, the method further comprises sending a signalling message to the first node acknowledging that the tributary slot granularity has been set.

Advantageously, the first value of tributary slot granularity is 1.25 Gbps and the second value of tributary slot granularity is 2.5 Gbps.

Advantageously, the first signalling message is a Link Management Protocol Link Summary message.

Another aspect of the invention provides a method of operating a first node in an optical transport network. The first node is connected to a second node by a link. The first node is capable of operating at a first value of tributary slot granularity and a second value of tributary slot granularity. The method comprises, at the first node, sending a signalling message which indicates that the second node should force a setting of the tributary slot granularity to a same value of tributary slot granularity that is configured at the first node.

Advantageously, the signalling message specifies the value of tributary slot granularity configured at the first node.

Further aspects of the invention further provide apparatus for implementing any of the described or claimed methods. In particular, an aspect of the invention provides apparatus for use at a second node of an optical transport network. The second node is connectable to a first node by a link. The apparatus comprises a transmission interface which is capable of operating at a first value of tributary slot granularity and a second value of tributary slot granularity. The apparatus further comprises a signalling interface for communicating with the first node of the network. The apparatus further comprises a controller which is arranged to receive a first signalling message from the first node. The controller is arranged to determine if the same value of tributary slot granularity is configured at the second node and the first node. If it is determined that the same value of tributary slot granularity is not configured at the second node and the first node, the controller is arranged to determine if the second node should force a setting of the tributary slot granularity. If it is determined that the second node should force a setting of the tributary slot granularity, the controller is arranged to force a setting of the tributary slot granularity to a same value as configured at the first node.

Another aspect of the invention provides apparatus for use at a first node of an optical transport network. The first node is connectable to a second node by a link. The apparatus comprises a transmission interface which is capable of operating at a first value of tributary slot granularity and a second value of tributary slot granularity. The apparatus further comprises a signalling interface for communicating with the second node of the network. The apparatus further comprises a controller which is arranged to send a signalling message from the first node which indicates that the second node should force a setting of the tributary slot granularity to a same value of tributary slot granularity that is configured at the first node.

Another aspect of the invention provides a network which comprises a first node and a second node as defined above.

The functionality described here can be implemented in hardware, software executed by a processing apparatus, or by a combination of hardware and software. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to perform the required functions. Another aspect of the invention provides machine-readable instructions (software) which, when executed by a processor, perform any of the described methods. The machine-readable instructions may be stored on an electronic memory device, hard disk, optical disk or other machine-readable storage medium. The machine-readable medium can be a non-transitory medium. The machine-readable instructions can be downloaded to the storage medium via a network connection.

### BRIEF DESCRIPTION OF THE DRAWINGS

Embodiments of the invention will be described, by way of example only, with reference to the accompanying drawings in which:

FIG. 1 shows an Optical Transport Network (OTN);

FIG. 2 shows a Link Management Protocol between a pair of nodes of the network of FIG. 1;

FIG. 3 shows apparatus at one of the nodes of the OTN of FIG. 1;

FIG. 4 shows a method performed by a node of the network in accordance with an embodiment of the invention;

FIG. 5 shows an alternative to the method of FIG. 4;

FIG. 6 shows an example of signalling used in the methods of FIGS. 4 and 5;

FIG. 7 shows an example of a network where the method of FIG. 4 or 5 can be used;

FIG. 8 shows another example of a network where the method of FIG. 4 or 5 can be used;

FIG. 9 shows processing apparatus for a computer-based implementation of the method.

### DETAILED DESCRIPTION

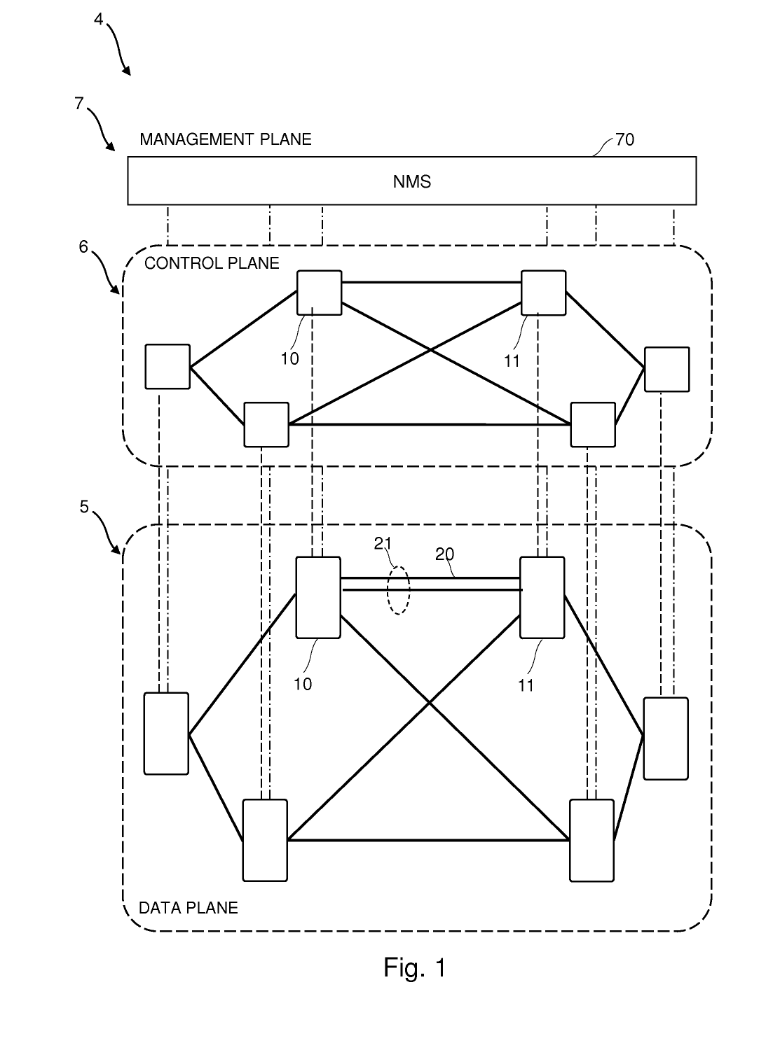

FIG. 1 shows an Optical Transport Network (OTN) 4. The network 4 comprises a plurality of nodes. Two nodes of the network 4 are shown as nodes 10, 11. The network 4 comprises a data plane 5, a control plane 6 and a management plane 7. Traffic-carrying paths are established between nodes 10 in the data plane 5 for carrying traffic across the network. Traffic can be carried on wavelength channels, which are also called lambdas. Each traffic path across the network 4 can use a different wavelength channel within a defined spectral band. This type of network can use a fixed or flexible grid of wavelength division multiplexed (WDM) or densely wavelength division multiplexed (DWDM) optical channels for lightpaths. The network can have a meshed, ring or any other suitable topology.

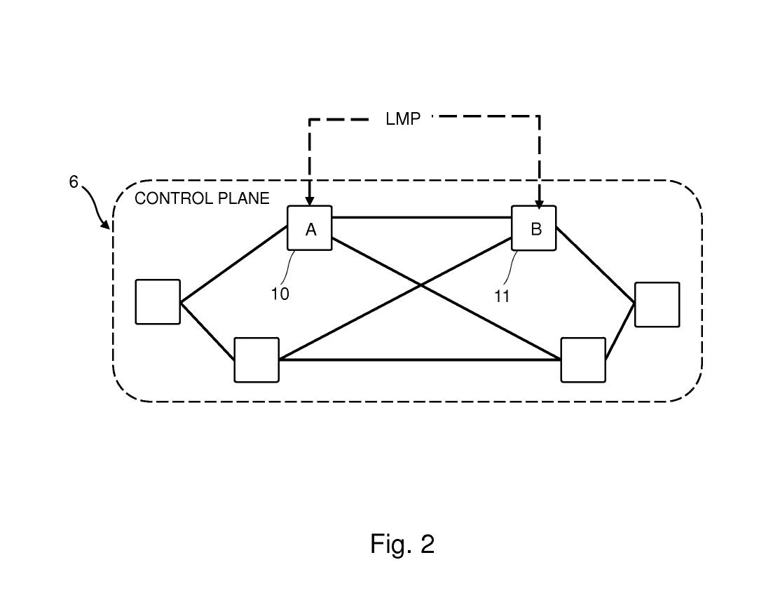

Traffic paths are set-up and torn down by control plane signalling, such as Generalised Multi-Protocol Label Switching (GMPLS) signalling. The term “traffic path” can be a Label Switched Path (LSP). In FIG. 1 the control plane is schematically shown as a separate layer 6 of the network 4, as it can use different resources compared to the data plane 5, such as using a separate fibre or wavelength compared to the traffic path to which the signalling relates. The GMPLS control plane signalling comprises a Link Management Protocol (LMP) which is defined in RFC4204. Network 4 can also comprise a management plane 7, which is represented in FIG. 2 by a Network Management System (NMS) 70. Nodes 10 can communicate with the NMS 70 via a management plane interface.

Adjacent nodes 10, 11 of the network are connected by physical links such as optical fibres. A data link 20 can be formed between an interface on a node 10 and an interface on a node 11. A group of data links 20 can be combined to form a Traffic Engineering (TE) Link 20. A sequence of data links 20 between nodes are used to form a lightpath across the network 4.

As shown in FIG. 2, the Link Management Protocol (LMP) is a protocol that runs between a pair of nodes (e.g. nodes 10, 11) and it is used to manage the network connectivity in terms of TE Links 21. LMP comprises two procedures. Firstly, the LMP verifies the reachability of the control channel interfaces that are used to carry control plane signalling between nodes. An Internet Protocol (IP) address is allocated to the control channel interface of each node. Secondly, the LMP performs link property correlation, which ensures the properties of the group of data links (20, FIG. 1) forming a TE Link (21, FIG. 1) are the same at both end points of the links.

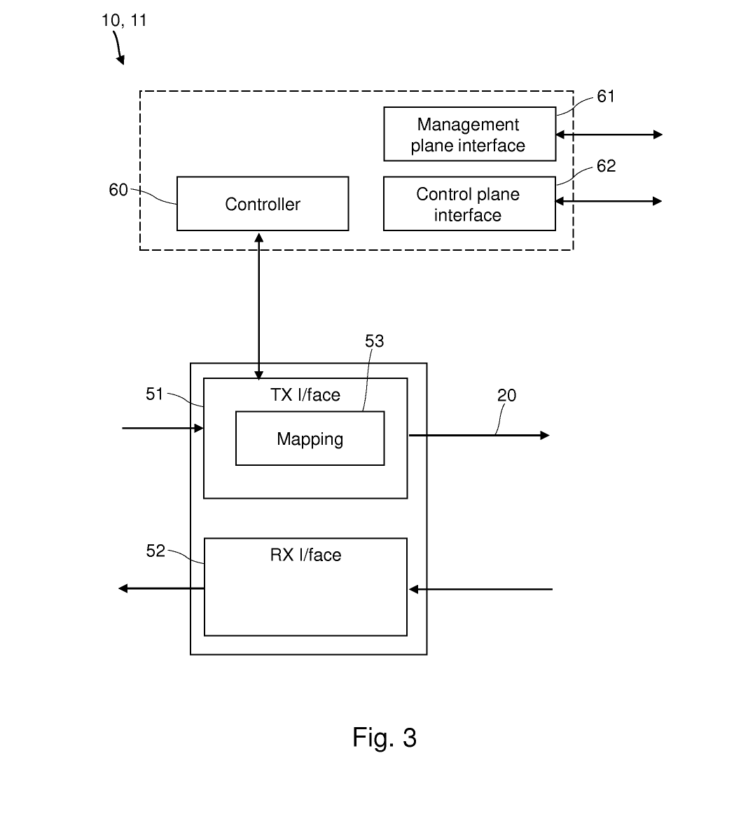

FIG. 3 shows an example of a node 10, 11 in the network 4. A transmission interface 51 provides a transmit end of a data link 20 as described above. A transmission interface 52 provides a receive end of a data link 20 as described above. A controller 60 controls operation of the transmission interfaces 51, 52. A control plane interface 62 is provided for interfacing with the control plane 6 of the network 4. The control plane carries the LMP signalling described above. A management plane interface 61 is provided for interfacing with the management plane 7 of the network 4. The transmission interface 51 comprises a mapping function 53 which maps traffic into particular Tributary Slots.

In ITU-T terminology, 2.5 Gbps is indicated with ODTUk.ts (or OPUk payload type=20) while 1.25 Gbps is indicated with ODTUk.jt (or OPUk payload type=21). Backward compatibility is left to the equipment.

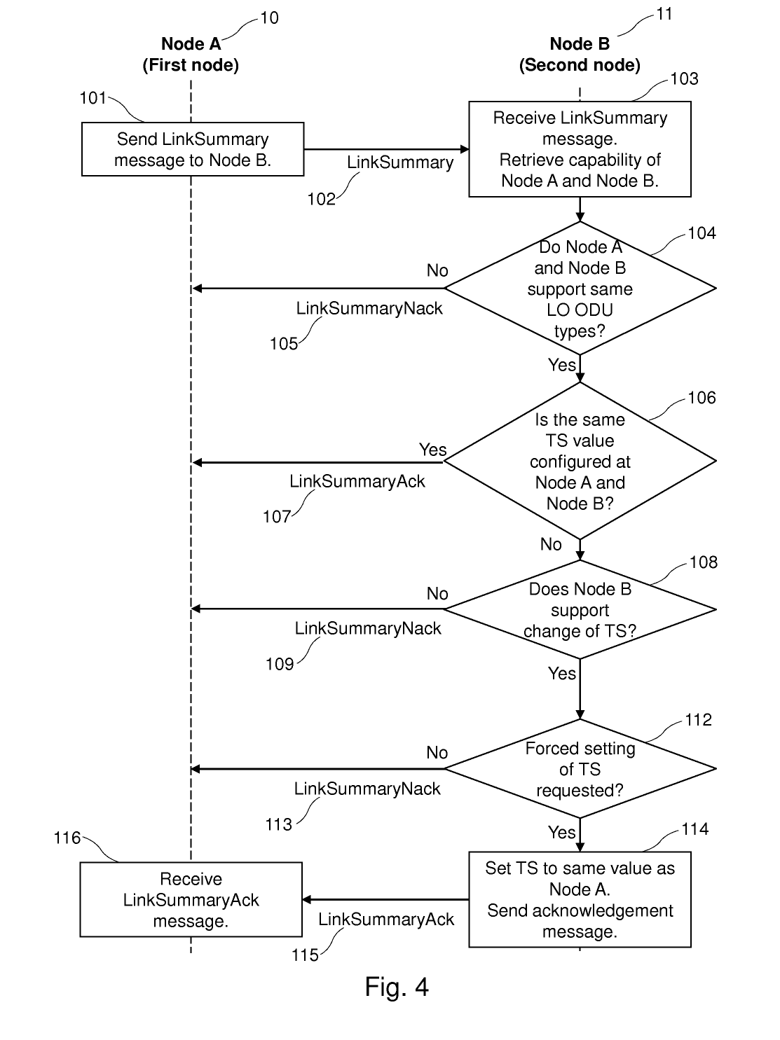

FIG. 4 shows an embodiment of a method performed at nodes 10, 11 of the network 4. For clarity, the first node, or local node, will be called Node A and the second node, or remote node, will be called Node B. At step 101, Node A sends a LMP Link Summary message 102 to Node B. The Link Summary message 102 carries information about properties of the TE Link, and can comprise a DATA_LINK object for each data link in the TE Link. The Link Summary message 102 can comprise an HO ODU Link Capability.TS Subobject which is used to tell the remote end of the HO ODU link which TS granularity and which LO ODU signal types that the local end can support. The HO ODU Link Capability.TS Subobject can be of the form described in IETF Internet drafts “Link Management Protocol (LMP) extensions for G.709 Optical Transport Networks”, draft-zhang-ccamp-gmpls-G.709-lmp-discovery-05.txt, and “Link Management Protocol (LMP) extensions for G.709 Optical Transport Networks”, draft-zhang-ccamp-gmpls-G.709-lmp-discovery-06.txt. The Link Summary message 102 also carries information which identifies the interfaces of Node A and Node B between which the TE Link is connected: a Local_Interface_Id which identifies an interface at Node A and a Remote_Interface_Id which identifies an interface at Node B. The Link Summary message 102 can also identify a TS value which Node A requests of Node B. This requested TS value is equal to a value of TS configured at Node A.

Node B receives the Link Summary message 102 at step 103. Step 103 matches the Local_Interface_Id and Remote_Interface_Id in the received message and retrieves information in the HO ODU Link Capability.TS Subobject.

Step 104 determines if Node A and Node B support the same LO ODU signal types. If not, a LinkSummaryNack message 105 is sent to Node A. If Node A and Node B support the same signal types, the method proceeds to step 106. Step 106 determines if the same TS value is configured at Node A and Node B. Step 106 can compare the value of TS configured at Node B with the value of TS indicated in the message 102 received from Node A. The TS configured at Node A is the one requested of Node B, i.e. the TS specified in the HO ODU Link Capability.TS Subobject of the message 102 received at step 103. If the same TS value is configured at Node A and Node B, Node B sends a LinkSummaryAck message to Node A. If the same TS value is not configured at Node A and node B, the method proceeds to step 108. Step 108 determines if node B supports a change of TS value. If node B does support a change of TS value, the method proceeds to step 112. Step 112 determines if a forced setting of the TS value has been requested. There are several possible ways of implementing this stage of the method.

In one advantageous implementation, the Link Summary message 102 carries an information element which indicates whether node B should force the TS value to the same value that has been configured at Node A. Step 112 can check the value of this information element in the received message 102. If a forced setting of TS value is required, the method proceeds to step 114 and node B forces the TS value to the same value as set at Node A. An acknowledgement message (LinkSummaryAck) 115 is sent to Node A. Node A receives the acknowledgement message (LinkSummaryAck) at step 116.

Step 106 of the method determines if the same TS value has been configured at Node A and node B. The value of TS configured for an interface at node B can result from a previous configuration operation of the interface, such as configuration to support a previous traffic path which is no longer in use. Another possibility is that the TS value configured at a node is a default value used by the node.

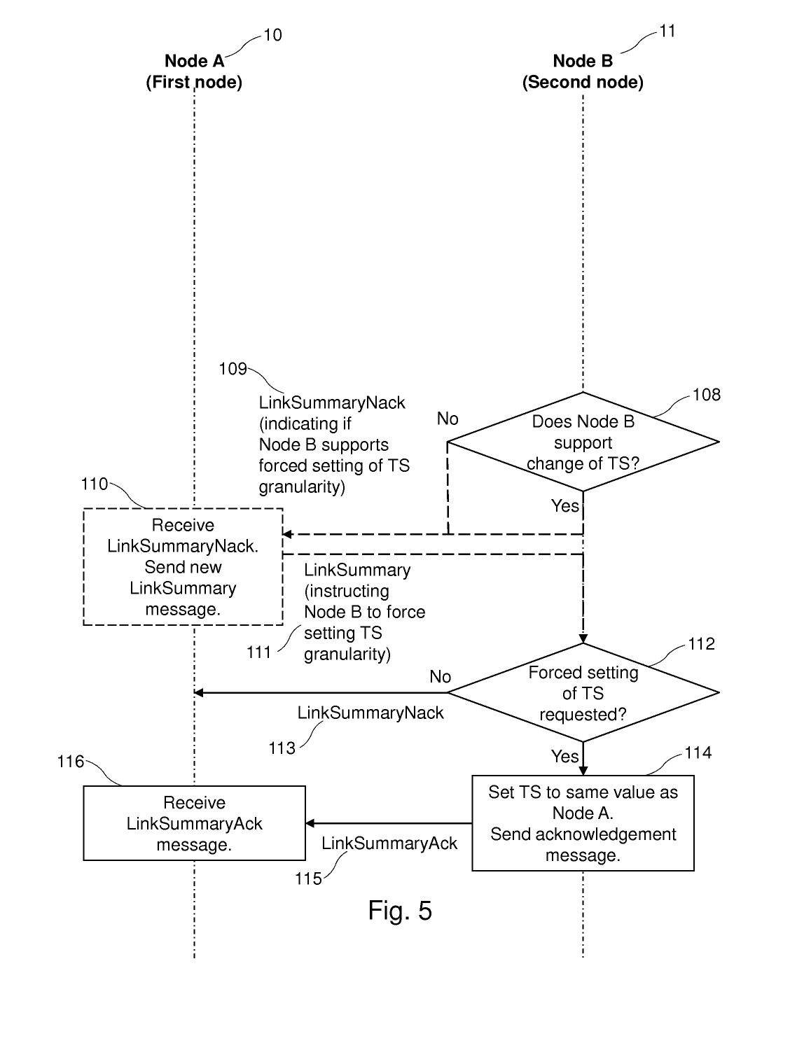

FIG. 5 shows another implementation of the part of the method which determines if a forced setting of the TS value has been requested. At step 108, Node B can send a signalling message (e.g. a LinkSummaryNack message) 109 to Node A. Message 109 indicates if node B supports a forced setting of TS value. Node A receives the message at step 110. In response to receiving the message, Node A can send a new signalling message 111 (e.g. a new Link Summary message) which instructs node B to force the setting of the TS granularity to the same value as Node A. If message 109 indicates that Node B supports a forced setting of TS granularity, and if a forced setting is required, Node A sends a signalling message 111 which instructs node B to force the setting of the TS granularity to the same value as Node A. From here, the method proceeds as described above. If step determines that a forced setting of TS value has been requested (via message 111), the method proceeds to step 114 and node B forces the TS value to the same value as set at Node A. An acknowledgement message (LinkSummaryAck) 115 is sent to Node A. Node A receives the acknowledgement message (LinkSummaryAck) at step 116.

It will be appreciated that some of the steps of FIGS. 4 and/or could be performed in a different order to that shown in FIG. 4. For example, the order of steps 106 and 108 could be reversed.

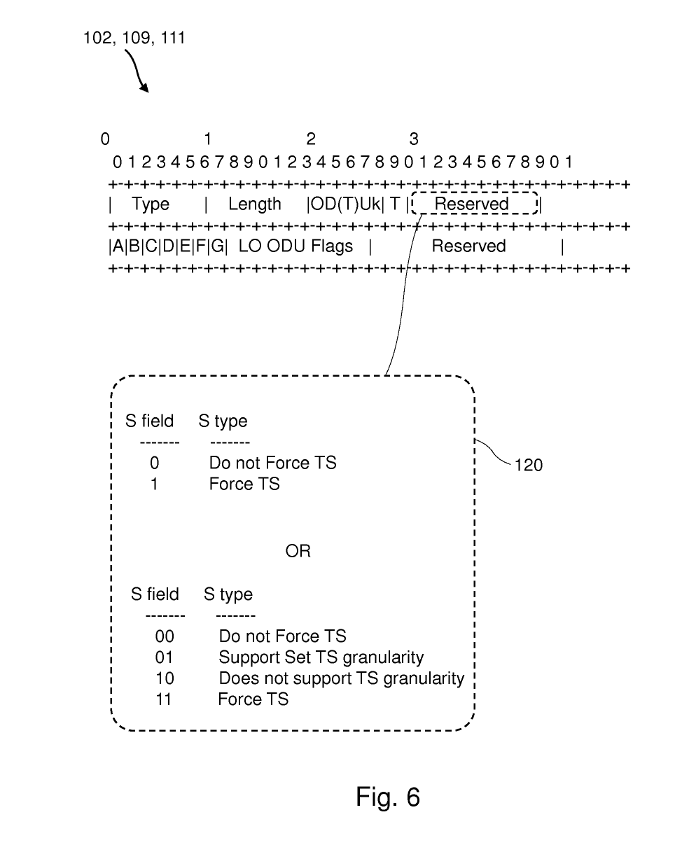

FIG. 6 shows an example format of a Subobject which can be carried within a Link Summary (or LinkSummaryNack) message. An information element 120 can comprise a single data bit which is set to a value “1” to instruct a node to force a setting of TS granularity or a value “0” to instruct a node not to force a setting of TS granularity. For the alternative implementation of FIG. 5, a two bit information element can carry an indication of whether a node supports setting of TS granularity and an instruction of setting TS granularity. It will be appreciated that information can be carried in a different way to the ones described here. For example, a different subobject can be used, or a different part of a subobject can be used compared to the one shown in FIG. 6.

Node A can compare a TS value requested by a traffic path to a value of TS configured at Node A. If the value of TS requested by a path is the same as the value of TS already configured at Node A, Node A can send a Link Summary message (e.g. at step 101 of FIG. 4) which carries an information element which indicates that Node B should force the TS value to the same value that has been configured at Node A.

Some examples will now be given of situations where the method can be used.

Case 1

Node A asks for Tributary Slot (TS)=1.25

Node A asks to set TS=1.25 on Node B

Node B supports TS 1.25 and 2.5

Current value at node A=1.25

Current value at Node B=2.5

Node B has the capability to change its TS granularity

Currently configured TS values at Node A and Node B are different. As Node A indicates it wishes to force setting of TS value, Node B forces a setting of TS value to the new value of 1.25, which is the same value as configured at Node A. Node B sends a LinkSummaryAck to node A.

Case 2

Node A asks for Tributary Slot (TS)=2.5

Node A asks to set TS=2.5 on Node B

Node B supports TS 1.25 and 2.5

Current value at node A=2.5

Current value at Node B=1.25

Node B has the capability to change its TS granularity

Currently configured TS values at Node A and Node B are different. As Node A indicates it wishes to force setting of TS value, Node B forces a setting of TS value to the new value of 2.5, which is the same value as configured at Node A. Node B sends a LinkSummaryAck to node A.

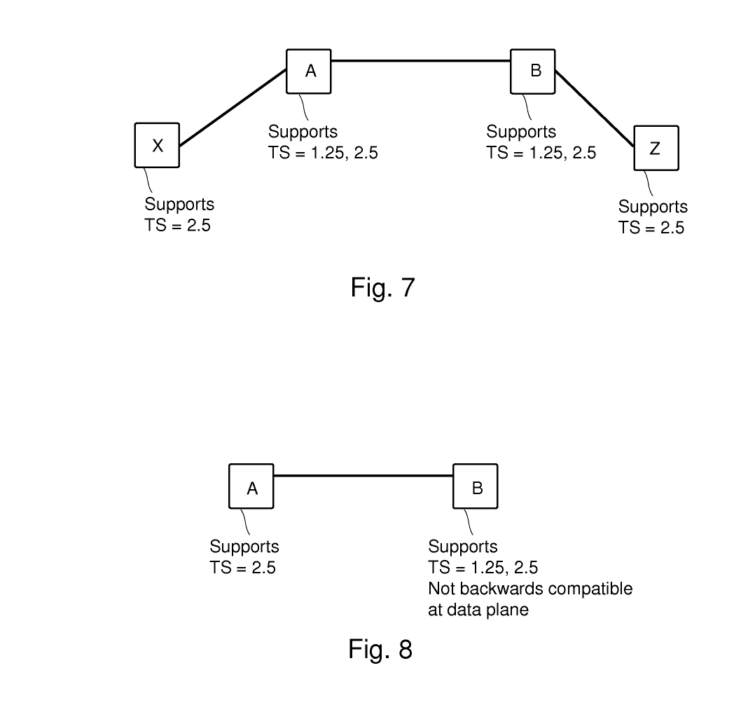

FIGS. 7 and 8 show two examples of situations where an embodiment of the invention can be used. A network comprises the nodes X, A, B and Z. Nodes X and Z only support TS=2.5. Nodes A and B support TS=1.25 and 2.5. Control plane signalling between nodes of the network will discover all of the TE Links between nodes. The LMP procedure will discover the network and, according to the procedure described in the IETF Internet draft “draft-zhang-ccamp-gmpls-G.709-lmp-discovery-05” will try to “adjust” the tributary slot value. As Node A and Node B support TS=1.25 this procedure will choose TS=2.5. Once the entire network is discovered and it is necessary to establish a path, a path computation engine in the network will find the optimal path. In the example of FIG. 7 a traffic path is required which starts at Node X, passes via Node A and Node B, and terminates on Node Z. The above procedure described in the IETF Internet draft “draft-zhang-ccamp-gmpls-G.709-lmp-discovery-05” does not allow this path because for the link between Node A and Node B, the TS=1.25 granularity is always chosen. Node X and Z may belong to a network compliant to G.709v1 while Node A and Node B may belong to a network compliant to G.709v3 with issue. The two networks must be able to interact. With the method described in embodiments of the invention, when the above path is requested the LMP tries to force TS=2.5 also on Node A and B and thereby allows the traffic path to be established.

FIG. 8 shows another example with legacy equipments deployed in a network at nodes A and B. Node A support TS=2.5. Node A may be a node which is compliant to G.709-V1. Node B supports TS=1.25 and TS=2.5. Node B may be a node which is compliant to G.709-V3. Node B may not be backwards compatible at the data plane level. This means that Node B may not automatically revert to TS=2.5 operation. In accordance with an embodiment of the invention, Node A can force a setting of the TS value at Node B to the same value as that at node A. This makes it possible to establish a traffic path at TS=2.5 between the legacy equipments at the two nodes.

Embodiments of the invention can be used with a pair of interfaces (i.e. an interface on a Node A and an interface on a Node B) that are both fully compliant to the latest issue of the G.709. Embodiments of the invention can also be used with a pair of interfaces where one of the interfaces is compliant to the latest G.709 recommendation issue and the other of the interface ports is compliant with issues of the G.709 recommendation prior to definition of the 1.25 TS.

In the case of interfaces fully compliant to the latest issue of the G.709, the method will correct automatically the TS mode where traffic can be transmitted between the two interfaces. If the Node A and the Node B have a different configured TS mode, a node can ask to the other the reconfiguration to be more flexible and able to support also latest mapping as ODUflex. Therefore in case on the Node A and the Node B, both compliant to the latest G.709 issue, if the interface port on the Node A is configured on TS 1.25G while the interface port on the Node B is configured on TS 2.5 G, the LMP protocol extension described above can force the reconfiguration of the TS mode on the interface port of the Node B in order that the two interface can interwork in the more flexible way based on the 1.25 TS mode supporting also the transport of ODUflex signals.

In the case of interworking between an interface port that is compliant to the latest G.709 recommendation issue and an interface port that is compliant with issues of the G.709 recommendation, prior to the definition of the 1.25 TS, consider the interface port on Node A (compliant with issues of the G.709 recommendation) is configured on TS 2.5G while the interface port on the node B (compliant to the latest G.709 recommendation issue) is configured on TS 1.25G. The LMP protocol extension described above can force the reconfiguration of the TS mode on the interface port of the node B in order that the two interfaces can interwork according to the 2.5 TS mode.

The signalling exchange described above, and shown in FIG. 4, can take place as part of the process to set up a new traffic path between a source node and a destination node. This requires interaction between LMP, Resource Reservation Protocol (RSVP) and Open Shortest Path First (OSPF). The interaction between these protocols is as follows:

1. LMP notifies RSVP and OSPF of the control channel and resources for a traffic engineering link.

2. GMPLS extracts LSP attributes from configuration data and requests RSVP to signal the new path, specified by the traffic engineering link addresses.

3. RSVP determines the local traffic engineering link, corresponding control adjacency and active control channel, and transmission parameters (such as IP destination). It requests LMP to allocate a resource from the traffic engineering link with the specified attributes. If LMP successfully finds a resource matching the attributes, label allocation succeeds. RSVP sends a PathMsg hop-by-hop until it reaches the destination node.

4. The destination node, on receiving the RSVP PathMsg, requests that LMP allocate a resource based on the signalled parameters. If label allocation succeeds, it sends back a ResvMsg.

5. If the signalling is successful, an RSVP LSP tunnel is provisioned.

The method shown in FIG. 4 can occur as part of step 3 above.

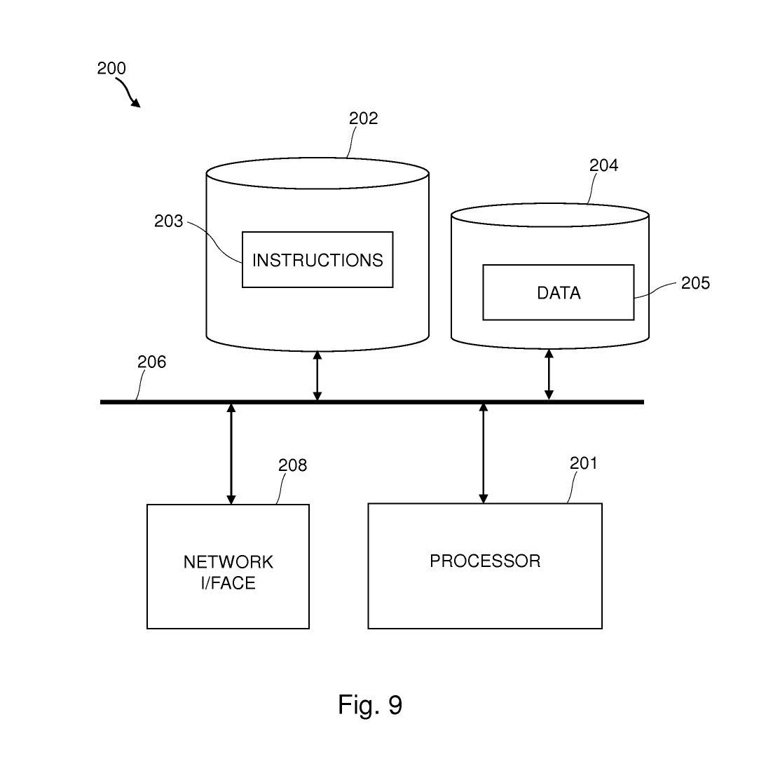

FIG. 9 shows an exemplary processing apparatus 200 which may be implemented as any form of a computing and/or electronic device, and in which embodiments of the system and methods described above may be implemented. Processing apparatus 200 can be provided at one of the nodes 10, 11. Processing apparatus may implement the method shown in FIG. 3 or 4. Processing apparatus 200 comprises one or more processors 201 which may be microprocessors, controllers or any other suitable type of processors for executing instructions to control the operation of the device. The processor 201 is connected to other components of the device via one or more buses 206. Processor-executable instructions 203 may be provided using any computer-readable media, such as memory 202. The processor-executable instructions 203 can comprise instructions for implementing the functionality of the described methods. The memory 202 is of any suitable type such as read-only memory (ROM), random access memory (RAM), a storage device of any type such as a magnetic or optical storage device. Additional memory 204 can be provided to store data 205 used by the processor 201. The processing apparatus 200 comprises one or more network interfaces 208 for interfacing with other network entities.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

1-19. (canceled)

20. A method of operating a second node in an optical transport network, wherein the second node is connected to a first node by a link, and wherein the second node is capable of operating at a first value of tributary slot granularity and a second value of tributary slot granularity, the method comprising, at the second node:
receiving a first signaling message from the first node;
determining if the same value of tributary slot granularity is configured at both the first and second nodes;
in response to determining that the same value of tributary slot granularity is not configured at both the first and second nodes, determining if the second node should force a setting of the tributary slot granularity;
in response to determining that the second node should force a setting of the tributary slot granularity, forcing a setting of the tributary slot granularity to a same value as configured at the first node.

21. The method of claim 20, wherein the first signaling message specifies the value of tributary slot granularity configured at the first node.

22. The method of claim 20:
wherein the first signaling message comprises an information element which indicates whether the second node should force a setting of the tributary slot granularity;
wherein the determining if the second node should force a setting of the tributary slot granularity comprises checking a value of the information element in the first signaling message.

23. The method of claim 20:
further comprising sending a signaling message to the first node indicating that the second node supports a forced setting of the tributary slot granularity;
wherein the determining if the second node should force a setting of the tributary slot granularity comprises determining if a further signaling message is received from the first node indicating that the second node should force a setting of the tributary slot granularity.

24. The method of claim 20, further comprising determining Lower Order Optical Data Unit (LO ODU) types supported at the first node and the second node.

25. The method of claim 20, further comprising sending a signaling message to the first node acknowledging that the tributary slot granularity has been set.

26. The method of claim 20, wherein the first value of tributary slot granularity is 1.25 Gbps and the second value of tributary slot granularity is 2.5 Gbps.

27. The method claim 20, wherein the first signaling message is a Link Management Protocol Link Summary message.

28. A method of operating a first node in an optical transport network, wherein the first node is connected to a second node by a link, and wherein the first node is capable of operating at a first value of tributary slot granularity and a second value of tributary slot granularity, the method comprising, at the first node:
sending a signaling message which indicates that the second node should force a setting of the tributary slot granularity to a same value of tributary slot granularity that is configured at the first node.

29. The method of claim 28, wherein the signaling message specifies the value of tributary slot granularity configured at the first node.

30. The method of claim 28, further comprising, prior to the sending, receiving a signaling message from the second node indicating that the second node supports a forced setting of the tributary slot granularity.

31. The method according of claim 28, wherein the first value of tributary slot granularity is 1.25 Gbps and the second value of tributary slot granularity is 2.5 Gbps.

32. The method claim 28, wherein the signaling message is a Link Management Protocol message.

33. An apparatus for use at a second node of an optical transport network, wherein the second node is connectable to a first node by a link, the apparatus comprising:
a transmission interface which is capable of operating at a first value of tributary slot granularity and a second value of tributary slot granularity;
a signaling interface for communicating with the first node of the network;
a controller circuit configured to:
receive a first signaling message from the first node;
determine if the same value of tributary slot granularity is configured at both the first and second nodes;
in response to determining that the same value of tributary slot granularity is not configured at both the first and second nodes, determine if the second node should force a setting of the tributary slot granularity;
in response to determining that the second node should force a setting of the tributary slot granularity, force a setting of the tributary slot granularity to a same value as configured at the first node.

34. The apparatus of claim 33, wherein the first value of tributary slot granularity is 1.25 Gbps and the second value of tributary slot granularity is 2.5 Gbps.

35. The apparatus of claim 33, wherein the signaling message is a Link Management Protocol message.

36. An apparatus for use at a first node of an optical transport network, wherein the first node is connectable to a second node by a link, the apparatus comprising:
a transmission interface which is capable of operating at a first value of tributary slot granularity and a second value of tributary slot granularity;
a signaling interface for communicating with the second node of the network;
a controller circuit configured to send a signaling message from the first node which indicates that the second node should force a setting of the tributary slot granularity to a same value of tributary slot granularity that is configured at the first node.

37. A optical transport network, comprising
a first node of the optical transport network,
a second node of the optical transport network;
a link connecting the first and second nodes;
wherein the first node comprises:
a first transmission interface which is capable of operating at a first value of tributary slot granularity and a second value of tributary slot granularity;
a first signaling interface for communicating with the second node;
a first controller circuit configured to send a signaling message from the first node which indicates that the second node should force a setting of the tributary slot granularity to a same value of tributary slot granularity that is configured at the first node;
wherein the second node comprises:
a second transmission interface which is capable of operating at the first value of tributary slot granularity and the second value of tributary slot granularity;
a second signaling interface for communicating with the first node;
a second controller circuit configured to:
receive the signaling message from the first node;
determine if the same value of tributary slot granularity is configured at both the first and second nodes;
in response to determining that the same value of tributary slot granularity is not configured at both the first and second nodes, determine if the second node should force a setting of the tributary slot granularity;
in response to determining that the second node should force a setting of the tributary slot granularity, force a setting of the tributary slot granularity to a same value as configured at the first node.

38. A computer program product stored in a non-transitory computer readable medium for controlling a first node of an optical transport network, wherein the first node is connected to a second node by a link, and wherein the first node is capable of operating at a first value of tributary slot granularity and a second value of tributary slot granularity, the computer program product comprising software instructions which, when run on a controller circuit of the first node, causes the first node to:
send a signaling message which indicates that the second node should force a setting of the tributary slot granularity to a same value of tributary slot granularity that is configured at the first node.

39. A computer program product stored in a non-transitory computer readable medium for controlling a second node of an optical transport network, wherein the second node is connected to a first node by a link, and wherein the second node is capable of operating at a first value of tributary slot granularity and a second value of tributary slot granularity, the computer program product comprising software instructions which, when run on a controller circuit of the second node, causes the second node to:
receive a first signaling message from the first node;
determine if the same value of tributary slot granularity is configured at both the first and second nodes;
in response to determining that the same value of tributary slot granularity is not configured at both the first and second nodes, determine if the second node should force a setting of the tributary slot granularity;
in response to determining that the second node should force a setting of the tributary slot granularity, force a setting of the tributary slot granularity to a same value as configured at the first node.
